(19) United States
(12) Patent Application Publication
(10) Pub. No.: US 2006/0183094 A1
(43) Pub. Date: Aug. 17, 2006

(54) Aid to idea processing and/or a method of planning or holding a meeting

(76) Inventors: David Lawrence Herman, Auckland (NZ); Lee Whitney Herman, Wellesley, MA (US)

Correspondence Address: YOUNG & THOMPSON, 745 SOUTH 23RD STREET, 2ND FLOOR, ARLINGTON, VA, 22202, US

(21) Appl. No.: 10/548,099

(22) PCT Filed: Mar. 4, 2004
(86) PCT No.: PCT/NZ04/00044

§ 371 Date: Apr. 6, 2006

(30) Foreign Application Priority Data
Mar. 5, 2003 (NZ) 524571

(51) Int. Cl. G09B 19/00

(52) U.S. Cl. 434/236

(57) ABSTRACT

An aid to idea processing includes a viewable information carrier. The carrier has areas capable of receiving relevant notations of a process directed to an objective so as to represent the essentially dynamic relationships in a structural manner. The invention also includes a method of planning or holding a meeting including the steps of preparing an aid to idea processing as above and distributing the prepared aid to idea processing to intended recipients at the meeting. The attending attendees amend the aid to idea processing or prepare further aids to idea processing. The amended and/or further aids to idea processing are then collected.

### TECHNICAL FIELD

This invention relates to an aid to idea processing and/or a method of processing ideas and has been devised particularly though not necessarily solely to assist in the planning conducting or expediting of meetings, to function as a meeting surrogate or assisting one's own development of a topic.

### BACKGROUND

Arguments supporting or opposing business ideas are sometimes “bottom line”, discrete quantitative, “right angled” (e.g. based solely on the competition's selling price) but most often they are not. Business meetings are more often focused on complex plans and strategies—and are thus often essentially dynamic (and non-quantitative) in their essential nature. Every argument to act or not to act on an underlying issue represents a “force” to be reckoned with.

These meetings and their proceedings are almost always complex, multi-dimensional and dynamic in scope. For instance, a plan deciding on whether or not to produce and market an ordinary biscuit—very cost-competitive at bottom—is tied also to a multitude of varied, multi-levelled contingencies such as current consumer tastes, competition brand name recognition, changing diet trends and so on. These variables reflect dynamic forces played out on all levels of reality, and therefore judgements made with these considerations in mind are likely to be finally “totalistic” accretive, amalgam-like more-or-less educated guesses as to what are likely to be good bets “about anything and everything”—“after all is said and done.” There are no devices on the market, nor have there ever been, which facilitate (largely) qualitative comprehensive, holistic, “all-in-one” judgements and decisions.

Often, given these overwhelming complications, such meetings have a difficulty progressing from an initial point in the meeting to a final point. The participants must rely on a wide ranging discourse to convey their intentions and responses in the essentially dynamic process which is taking place. Notwithstanding that there may be some pre-discussion relating to the subject of the meeting, once the meeting begins substantial time is often used in going over the subject. It may be thought that there could be a structural way to avoid these problems, and to collapse concepts and plans of action into underlying proposed templates encompassing the entirety of the plan and its supporting ideas. However to date no such structural way exists.

For the purposes described above, standard flow charts are clearly insufficient, as these devices merely illustrate parallel concatenations of genealogically ordered occurrences of separate events relating one to another, but not to the totality of the entire process and not to the dynamic heart and context of the proposal. Flow charts fail to reveal the entire thrust and synergy of the process they purport to “cover”.

### OBJECT OF THE INTENTION

It is therefore an object of the present invention to provide an aid to idea processing and/or a method of planning or holding a meeting which will obviate or minimise the foregoing disadvantages and/or meet the foregoing requirements in a simple yet effective manner or which will at least provide the public with a useful choice.

The function of the invention is to facilitate meetings: specifically meetings held to review a proposed idea i.e. a plan, project, etc. The heart of the invention is an information carrier template which is the preferred form of invention provided. It presents the plan (and all its features) in such as way that meeting attendees are kept focused on core issues. The template can be used as a guideline at face-to-face meetings to keep discussions on track. If the template is transmitted electronically back and forth between meeting attendees and these communications resolve issues—then the template is functioning as a meeting surrogate and in a sense it IS the meeting.

### STATEMENT OF THE INVENTION

Accordingly in one aspect the invention consists in an aid to idea processing comprising a viewable information carrier, the carrier having areas capable of receiving relevant notations of a process directed to an objective so as to represent the essentially dynamic relationships in a structural manner.

Preferably the carrier prompts idea originator notations.

Preferably the carrier is contained in an electronic storage device in association with electronic data processing means.

Preferably the carrier comprises a template.

Preferably the template prompts identifications of problems and/or opportunities to be considered.

Preferably the template prompts identifications of causal features and/or precursors to action and/or non-critical problems and/or impedimental factors.

Preferably the template prompts identifications of resources, operation exigencies, loosened constraints.

Preferably the template prompts identifications of generative and/or structural elements.

Preferably the template prompts identifications of operative elements or agents.

Preferably the template prompts the identification of the operations themselves.

Preferably the template prompts identification of an objective of positive operative elements.

Preferably the template prompts identification of one or more initial benefits, long term benefits, ancillary consequences, negative consequences, and/or remedies.

Preferably the template provides areas for positive notations and areas for negative non-critical, or irrelevant notations.

Preferably the template further prompts proposed future consequences of future actions, and objectives.

In a further aspect the invention consists in a method of planning or holding a meeting consisting of one or more persons, comprising the steps of preparing an aid to idea processing according to any one of the preceding paragraphs, distributing the prepared aid to idea processing to another intended attendee or to other intended attendees at the meeting, allowing the attending attendee/attendees to amend the aid to idea processing or prepare further aids to idea processing and collecting the amended and/or further aids to idea processing.

Preferably the intended attendee or attendees comment on the material in the aid to idea processing.

Preferably the distribution and collecting of the aid to idea processing is performed at least in part through one or more of an electronic network of electronic data storage and processing devices, facsimile machines, pen or pencil and paper, and chalkboards.

Preferably the aids to idea processing are electronically stored to be available to assist preparation of later aids to idea processing.

Preferably the aids to idea processing are coded to allow retrieval of the aids to idea processing at a later date.

Preferably the code relates to the issues or types of decision to be made at the meeting.

Preferably the data processing means provides prompts for notations based on past aids to idea processing of the aid to idea processing currently being prepared.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which

FIG. 1 is a basic diagrammatic representation of an aid to idea processing according to one form of the invention providing a general view of the idea processing event.

FIG. 2 provides a diagrammatic sequence of steps in planning a meeting which also serves as an aid to idea processing according to the invention relating to a developed more specific idea processing event.

FIG. 3 is a view of a proposal template for use in the invention as shown in FIG. 2, and

FIG. 4 is a view of an action plan and goals template for use in the invention as shown in FIG. 2.

Referring to the figures, an idea processor and/or a method of planning or holding a meeting are provided as follows.

### BEST MODE FOR CARRYING OUT THE INVENTION

Using the Template

The function of the aid to idea processing of the invention is to facilitate meetings: specifically meetings held to review a proposed idea i.e. a plan, project, etc. The heart of the invention is an information carrier which in the preferred form of the invention is provided in the form of a template. It presents the plan (and all its features) in such a way that meeting attendees are kept focused on core issues. The template can be used as a guideline at face-to-face meetings to keep discussions on track. If the template is transmitted electronically back and forth between meeting attendees and these solely electronic communications resolve issues—then the template is functioning as a meeting surrogate and in a sense it IS the meeting.

Overview

The template allows the originator to outline an idea unambiguously, intelligibly, and concisely, and to communicate the idea, spread on the template, to one or more interested recipients. This process makes it easier for all meeting attendees to make assessments and decisions in the shortest possible time.

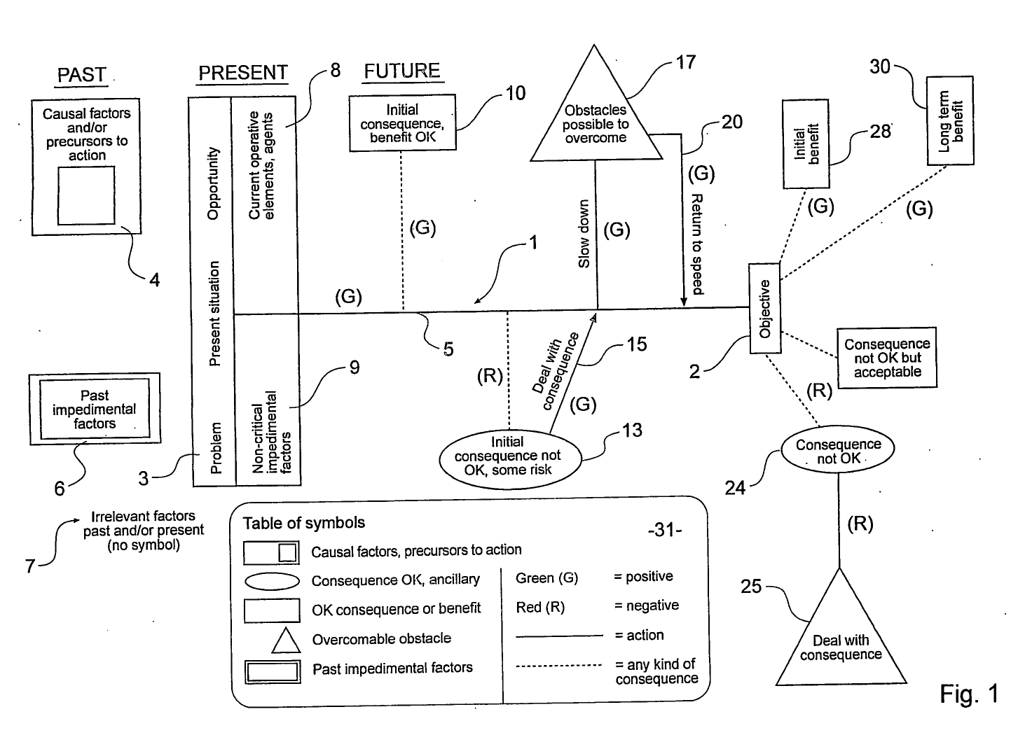

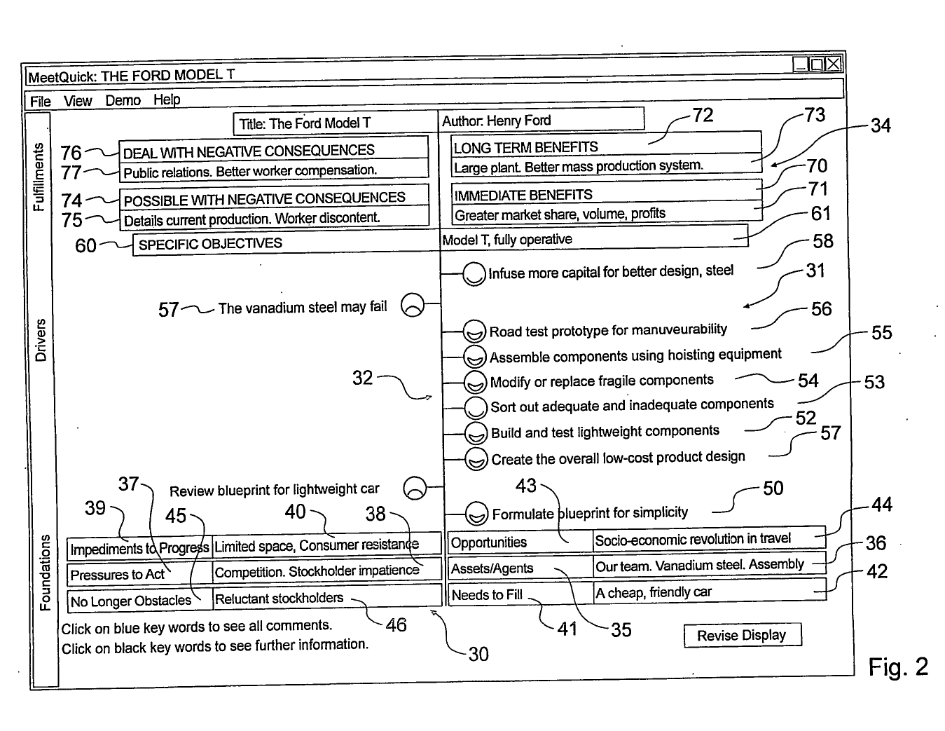

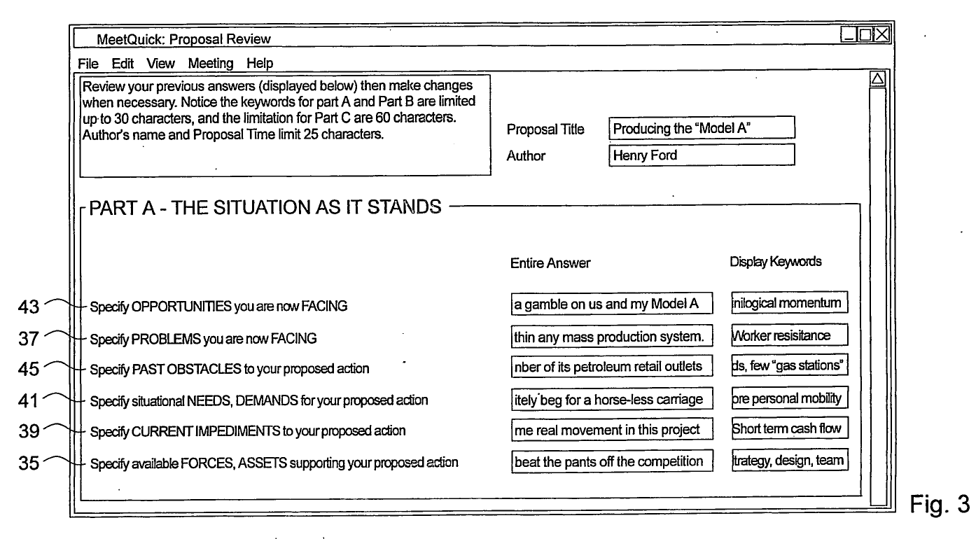

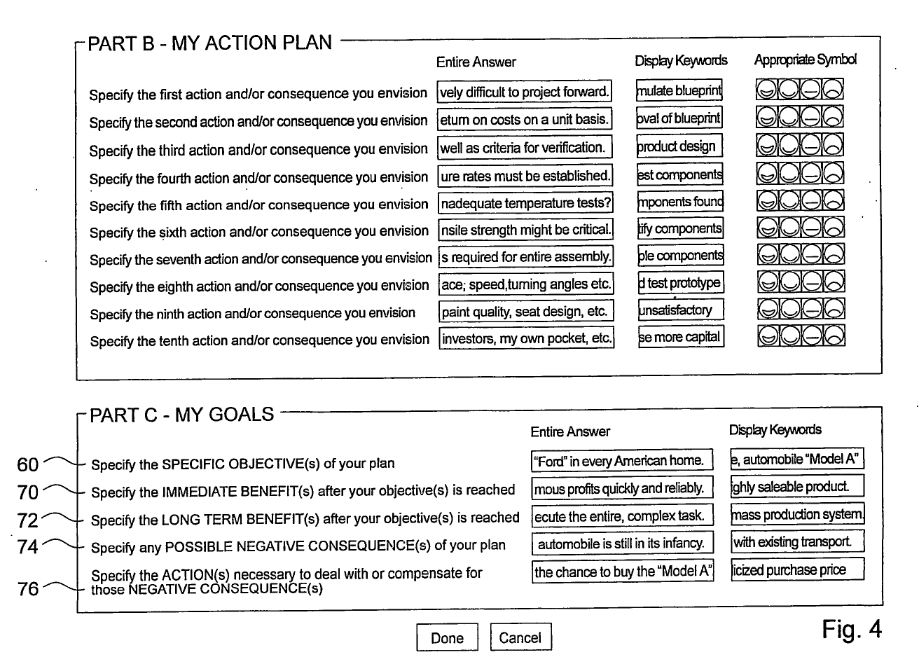

A person planning to call a meeting procures the aid to idea processing, for example as shown in the FIGS. 2 to 4, for example. In the preferred form of the invention this would be retrieved from a database associated with electronic data processing means. The aid in the form shown in FIG. 1 where the actions progress along a substantially horizontal line, includes a space, location 1, to insert a notation indicating the intended action which might be, for example, “let us plan, contract out and have constructed a building.” At location 2 an objective to which the action is directed is inserted. This could be “so as to have a factory at location X”, for example.

The problem/opportunity from which the action is launched can be expanded at location 3 by listing causal factors and/or precursors to the action and/or impediments in the general area 4. This area will usually contain a problem or window of opportunity. The meeting planning aid is divided into at least two and preferably three parts, for example by a line 5, which in this case is shown horizontally across the page. Generally speaking positive matters are placed above the line and negative or irrelevant matters below the line. Thus for a particular problem/opportunity past impedimental factors are listed below the line at area 6. Above the line are included the most relevant factors. Past problematic matters are listed at area 7 to show that they have been considered by the person completing the aid. These are “past” matters.

Adjacent the problem opportunity area is provided a further area 8 to enable current operative elements including resources to be listed and this is matched by a list of non-critical impedimental factors indicated at 9. These are “present” matters.

Initial consequences can be listed at 10, whilst below the line can be provided more adverse consequences or those where there is some risk at 13. These commence the “future” area of the template.

Steps to deal with such adverse consequences can be indicated at 15. For example, “the work should slow down until the obstacle can be overcome” as shown at 17, but once overcome or met the project would return to speed as is indicated by entry 20. Depending on the circumstances, the problem and its' solution can be shown substantially in the same place.

Consequences which are not acceptable are listed at 24 and suggestions to deal with these at 25. Provision can be provided at 26 to list consequences which are not acceptable, but could be lived with if desired.

Initial benefits are entered at 28, and longer term benefits are entered at position 30.

Of course other relevant matters could be included in the planning aid.

Colour can be used if desired and in the described embodiment positive factors are green [G], and negative red [R]. Differing symbols can be used to indicate differing types of matter as shown in the table of symbols 31.

It is envisaged that the aid would then be distributed to persons that were intended to attend the meeting.

It is envisaged that aids could be grouped into subject matter groupings, for example, plant, staff, hours, policy matters and the like, and access to those earlier planning aids could be provided through the electronic data processing means or to collated entries for meeting planning aids developed for meetings of a similar type. This would have the advantage of suggesting to attendees, and in particular the original meeting aid compiler the sort of questions that had been considered before when the compiler or other person is attempting to place entries into the prompted factors.

The use of the invention in this form is substantially as set forth above in that a person desiring to call an electronic or face to face meeting or a person appointed by the meeting caller would prepare an aid of the type described above for electronic distribution and for electronic collection and collation of any replies. This has the advantage that at least in the preferred form, when, and if, the attendees attend the electronic meeting (the necessity to call a face to face meeting may have been obviated, given the explanatory power of the template) the attendees are fully conversant with the action, objective and various issues that could arise because of the notations contained on the aids which have been distributed. The meeting can be in one place, at a distance, intermittent or even with oneself. In effect the template can be a meeting surrogate.

The meeting, if it does occur, and attendees having been supplied with the template, can proceed with little or no conversation merely considering earlier comparison modifications or complete reconstructions of the template (as originally submitted) by the attendees.

The alteration of the template or the inclusion of all comments may, and usually would, mark the end of the meeting for each attendee. When the template is distributed then responses could include, veto, critical response, or alteration. This has the advantage that when attendees attend they are conversant with the action and are constrained to deal only with the issue at hand.

In order to complete the template a number of questions can be put to the originator. By way of example the following questions can be put. The order is important but not critical for correct development.

1. What is the present situation ie. the “starting point” from which the action is launched (to rectify, improve, alter etc)?

2. What action are you recommending?

3. What is the objective toward which this action is directed?

4. What are the relevant factors whose existence will make the action possible?

5. What are the no-longer-constraining factors?
The purpose of these questions, and the order in which they appear, is to ascertain the relevant elements for launching the action and which, in the course of their owner's identification, help define the very nature of the action. Therefore they are illustrated as the foundation of that action.
6. What are the initial or early impediments to the proposed action, if any?
Are the impediments significant and how can we work through these impediments?

7. What are the initial (mid-action) consequences?
(a) Okay
(b) Not okay
   (i) How to deal with the consequence.

8. What is/are the initial benefit(s)?

9. What is/are the long term benefit(s)?

10. What are the favourable ancillary consequences?

11. What are the unfavourable ancillary consequences?
(a) How to deal with them.
Questions can then be put to the receiver(s) of the original template and answers included on the template. Again, by way of example, the questions could be:
(i) spell out your assent or objection to the owner's model.
   If the receiver(s) does/do not assent to the originator's model, he/they creates his/her/their own model using the same set of questions as did the originator creates his/her/their viable plan, or depict his/her/their own personal view of the present and projected future of the enterprise as he/she/they see(s) it if the originator's model is implemented.

The templates can be transferred on any suitable carrier including electronic networks of electronic data storage and processing devices, pen or pencil or paper, facsimile machines or chalkboards, for example.

Referring now to FIGS. 2 to 4, the aid has been developed further. The action runs vertically. The template is divided into three sections. It describes the idea in terms of its background, its strategy and its goals. All three sections are given equal emphasis.

Action Foundations

The background of the plan is called the “Action Foundations”, and describes significant (past or present) conditions within the local business or professional environment. The Action Foundations 30 help support the argument for the plan.

Action Drivers

The strategy is called the “Action Drivers” and indicate practical steps that need to be taken (in the near future) to implement the idea. Satisfactory consequences of these steps are also identified in column 31 in the embodiment of FIGS. 2 to 4 both are shown on the right side of the template to show favourability.

Included with the Action Drivers are any unfavourable consequences that might arise as the plan moves ahead. These consequences must be identified as part of the Action Drivers, to explain the corrective measures that are like to be taken immediately or soon after. They are shown on the left side 32 of the template.

Action Fulfilments

The goals are called Action Fulfilments. These are what the plan achieves in the more distant future, the benefits of those achievements, and are the motivational forces of the plan. Possible negative consequences of the plan are also indicated in this section, as are the actions required to counteract them if they do in fact occur.

Each section of the template is divided into subsections indicating a specific feature of the originator's vision as outlined in the plan. Action Foundation (background) and Action Fulfilments 34 (goals) are enclosed within boxes. Each box contains comments and expands when double-clicked.

The Action Foundation section includes for example:

1. Opportunities

2. Assets/Agents

3. Needs to Fill

4. Impediments To Progress

5. Pressures To Act

6. No Longer Obstacles

Action Drivers appear in the middle of the page, and are each aniotated with (in the embodiment described) one of a series of faces, namely Positive Action, OK Consequence of an earlier action, Non-OK but fixable consequence, and High Risk Consequence (respectively green, light gray, dark gray, red, with expressions ranges from a broad smile to a deep frown).

The Goals section includes a number of categories listed as for example:

1. Specific Objectives

2. Short Term Benefits

3. Long Term Benefits

4. Possible Negative Consequences

5. Deal With Negative Consequences

Originator Instructions

How to Construct A Template

The template allows you to present a plan of action and its particulars within a single visual field. The originator answers a series of standard questions relating to the subordinate elements of the plan. Input is used to populate the appropriate fields that will identify each element and the significance of the element within the context of the plan. Just turn to the questions and answer them reasonably and intelligently, responding with “unsure at this stage” or “doesn't apply in this case” if appropriate. Also typed in are a few key words to identify the proposals.

An example is shown in FIGS. 2 to 4 based on the Ford Model T automobile. A double click on each of the boxes and faces to uncover the underlying data. The questions are answered. After the user has answered all the questions, the user should review the display to insure that it describes the plan. The user should scan back and forth across the template, examining all the elements in pairs and small groupings to maximize overall consistency. The identified Unfavourable Consequences and High Risk Consequences should be accompanied or followed by remedial actions. The elements identified as Assets/Agents should fulfil the requirements of the user's identified Needs/Demands. A Revise Display button is provided to bring up the questions once again.

Possible modes of use are as follows:

Shared Environment

The display is published electronically by the originator. The template can later be annotated with comments submitted by recipients at different times and in different locations.

E-Mail (2 Party Version)

The originator can also create a file and send it to the other party via e-mail. The originator can receive back a template annotated with commentary.

Face to Face

Participants gathered together in a conference room can review the originator's template and discuss all aspects of the idea, making appropriate changes directly to the template as the discussion proceeds.

Of course other modes of use are possible such as simple circulation of paper printouts.

Roles

The Originator

The Originator is person who, alone or as part of a group, constructs a template in order to communicate an idea to others. The idea is communicated in such a way that there is no doubt why or how the idea should be implemented. The Originator creates the template to insure that all responses are direct, appropriate and constructive.

The Recipient

The Recipient is a person who, alone or as part of a group, has been included in the meeting by the originator and who reviews the display on the template. The Recipient is presumed by the originator to have no previous familiarity with the idea, but hopefully a general knowledge of the environment in which the idea will be actualised.

Recipient advice. How to read a template and respond

The display is read from the bottom up (chronologically): Action Foundations 30, Action Drivers 31, and Action Fulfilments 34, clicking on all the category headings (e.g. No Longer Obstacles) brings up content that may help clarify their operative meanings (e.g. Conditions have changed and we can now act). Clicking on all originator inputs to uncover further information the originator has included. Thought is given to the following issues:

Action Foundations: Are they significant? Do they accurately reflect past and present issues? Do they lend support to the logic of the plan as a whole?

Action Drivers (shown in red, greys and green for example): Do they describe a credible progression of events? Do either the unfavourable or “high risk” consequences seem rectifiable as shown on the display? Does the plan seem to have a good chance of success, i.e. of achieving its Objective without serious consequences?

Action Fulfilments: Does it seem that the objective will produce the predicted Short Term Benefits? The Long-Term Benefits? Does it seem that the Negative Consequences of the plan are rectifiable or manageable as described?

Scan back and forth between all the elements on the display. Are they compatible? (For instance, in the Ford sample display, Impediments To Progress, is it likely that the consumer bias toward expensive cars will continue to present a problem for Ford once his Model T and its cheap price has been well advertised?

When the preview is completed, the user can double click on the boxes to which the user wants to respond (to the originator and/or to other recipients) and then click on the “Add Comment” button to enter the user's response. The user may also respond to comments from other recipients. Returning to the user's own comments at some future time to find, below, direct feedback from others.

Finally, if the user feels that he or she would like to alter the display and present a better plan, a template of that user can be created (See Originator Advice).

Details of the Template Boxes (Examples from the Ford Display are Included here for Purposes of Illustration)

Action Foundations

Assets/Agents 35

Our resources, human or material, immediate or potential.

Example (Ford Identifies his Personnel, Materials, Systems)

Our design team, Charley Sorensen, Harold Wills and Joe Galamb, is the best in the business. I have a lot of faith in them. I believe our improved lightweight vanadium steel alloy is going to stand up over all the jolts of the worst roads. Finally, our assembly line, although not yet perfect, will benefit from the new hoists I intend to include—this means less lifting and more output per worker.

Keywords 36: Our team. Vanadium steel. Assembly

Pressures to Act 37

Alarm bells calling for action.

Example (Ford Identifies Economic Pressures)

I'm afraid we may lose market share to one of the other Big Four companies. A few of them have put out some cheaper models, and even though they haven't sold all that well, somebody may come along and beat me to the first really cheap car. Our stockholders want greater profits and I think the only way we can double or triple our profits is to build a car almost anyone can afford.

Key words 38: Competition. Stockholders

Impediments to Progress 39

Potential problems lying before us that could slow us down or make things difficult.

Example (Ford Identifies Logistical and Psychological Impediments)

I'm concerned about the limited space in our present plant. I'm tired of bringing materials into one space and then assembling parts in another. We should be carrying out all operations under one roof. My other concern is the never-ending consumer resistance to “cheap” cars. They think you've got to spend big bucks to buy yourself a decent car.

Key words 40: Limited space. Consumers

Needs to Fill 41

Filling these needs (the world's or ours) will serve us.

Example (Ford Identifies Practical and Psychological Consumer Needs)

No matter what anybody think, I KNOW that a “friendly” car will sell like hotcakes. What are the consumer's real needs? For a safer car (left hand drive?) For maneuverability on bad roads. For a car they can sometimes fix themselves, with a screwdriver, a little bit of wire, etc. . . . For a car they can trust.

Key words 42: A cheap, friendly car

Opportunities 43

A shift in internal or external conditions to our advantage.

Example (Ford Identifies Favourable Socioeconomic Trends)

Things out there are changing a mile a minute. Housewives are getting independent and want to travel to the shops by themselves. Small businesses are getting bigger every day and owners want to make their “rounds” for hundreds of miles. There's a huge urban swing to the suburbs, and professional people are going to want to commute back and forth from the city on their own schedules.

Key words 44: Socio-economic revolution.

No Longer Obstacles 45

Conditions, once constraining us, have changed for the better and we can now act.

Example (Ford Identifies a Past Problem which No Longer Exist)

I am pleased to report that we can now move ahead with my plan for a cheap mass-produced car—without have to worry about trouble from inside the company. You all know there was resistance form Malcomson. Well that's all over and done with now. He's out of the picture.

Key words 46: Reluctant stockholder.

Action Drivers

This is a sample of Ford's plan. It demonstrates a clear progression of steps taken toward an objective.

Producing the Model T

Formulate blueprint 50 (create private, secluded workspace). I'll provide the sketches—high chassis, simple body, left side drive. Completely enclosed.

If we complete the blueprint I'll OK it and give the go-ahead.

Create the overall product design 51 with Charley Sorensen. Miniature model will be made of wood again. Design should be extremely simple. Don't worry about “style”, that's for rich folks.

Build and test components in plant 52, after hours. Must be easy to repair or change. Use vanadium steel wherever possible. Engine with bolt-down cylinder head for easy removal.

Sort out adequate and inadequate components 53. A one-piece magneto ignition might prove to be a problem. Is the crank mechanism too stiff? Ball bearing problem?

Modify or replace new components 54. In some instances, try going back to unalloyed steel, back to battery ignition.

Assemble components on an improved assembly line 55. We need better transport of engines, car bodies to workers on the line. Try overhead hoists to eliminate heavy lifts.

Road test prototype 56 under tough road conditions. Roads should be muddy with deep ruts. Will the transmission “jump” the car over them? Will the large wheels help? The flexible body?

The entire prototype 57—as a concept—may fail. You never know. Will it come in on budget? Will it be strong enough for the light frame and powerful engine? Will the left hand drive prove safer?

Infuse more capital 58 (mine) to improve the prototype. We might have to compromise with new bearings in the crank, new balance of weight load, lower body height.

Action Fulfillments

Specific Objective 60

This is the specific goal of the plan.

Example (Ford Identifies His Specific Objective)

The Model T Ford, mass-produced, is going to be around for a long time. By this I mean we're not going to have to come out with a new model every year or so. The Model T will be as standard as a horse and buggy.

Key words 61: Prototype automobile Model T

Immediate Benefits 70

What will achieving the objective accomplish immediately or in the short run. What needs of ours/others will it fill?

Example (Ford Identifies His Broader Business Goals)

Greater profits on a high volume basis is the formula for success these days. And greater market share means beating some of our competitors into the ground. I want Ford to become a giant in the industry. The only giant.

Key words 71: Greater market share, volume, profits

Long term Benefits 72

What will achieving the objective accomplish in the long run? How will we be better off? What needs of ours/others will it fill?

Example (Ford Identifies Several Technological Goals to be Achieved over a Longer Period of Time)

I want our company to be known as the leader in a new, reliable mass production system (all—and I mean all—operations on the conveyor belt and work around the clock in 3 shifts). A new, all-purpose parts and assembly plant at Highland Park should suit this operation perfectly.

Key words 73: Large plant. Better mass production system

Possible Negative Consequences 74

Could the achievement of our objective also create problems for us?

Example (Ford Identifies Potential Business and Industrial Relations Problems)

Our new production system, design and materials will dramatically alter our current production style. And there may be no turning back to the old ways after this. The result? Profit loss? Reputation loss? We've also need to face up to the possibility of worker dissatisfaction the tediousness of mass production and the longer hours they may have to put in, at least for a while.

Key words 75: Derails current production. Worker discontent

Deal with Negative Consequences 76

If implementing our plan has negative consequences, can they be managed, offset or “lived with”?

Example (Ford Identifies a Number of Possible Public and Employee Relations Solutions)

Will the public go for our new (simple) design? If not we can always get testimonials from wealthy customers more than happy to own a “poor man's car”. How about holing publicised road tests including races, cross-country trips etc.? As for the workers, if we are forced to, we can always add more production shifts with fewer hours per shift. And why not higher pay for our workers? They'll deserve it.

Key words 77: Public relations. Better worker compensation.

The invention provides a communication template which strips a plan of action to its bare bones. In doing so it purposely highlights the issues and limits the scope of review to relevant matters for purposes of expediency and time saving. It accomplishes this by reducing the possibility of a misreading or misinterpretation, and, most importantly, of straying from the essence of the plan into irrelevancies.

The template is comprehensive, includes depictions of all future contingencies foreseen by the sender and, as well, the central dynamics driving the proposed action or project. Thus any subsequent review of the proposal by the receiver (or self review by the sender) is likely to be swift and yet deep in its analysis and comprehension. This template also forces the sender and receiver to “stick to the point” and can be used to shorten or even eliminate meetings (which are often time consuming and inefficient). If face to face meetings are still necessary, and are still called, this device can be used to keep the assemblage on track.

The invention achieves what may seem at first to be a contradiction in that by highlighting issues it organises, simplifies and clarifies the plan of action, what the plan is, in today's terminology, “all about”. It achieves this by using an unusual explanatory power, by insuring that the plan's identified “action foundation”, its “action driver” (or drivers) ie. Its precursive elements or agents are tied visually and conceptually with a wide umbrella to the entire action, consequences, and action fulfilment, along with the originators foreseen hindrances and obstacles. The invention has been described in a business environment but clearly can also be used as a personal idea checker (ie a “thought straightener-upper” or “idea distiller”), an inventory planner, a family issue resolver, a sales tool as it can illustrate how a product will be received. Furthermore as the records are in terms of personnel the number of useful comments per person can be logged.

All in all, the viability of the suggestion can be clearly inferred from the template and can be assessed knowledgeably by both sender and receiver, allowing plan amendments or corrections to be easily counter-communicated within the form of the template. Accordingly an issue is readably analysed or contextualised.

Put another way, the template organises and helps process complex and hetrogenous ideas so that the mind can combine them into unified, “totalized” judgments. Put even more simply, The template makes possible the comparison and assessment of “apples and oranges”—ie a multiplicity of various human actions and/or environmental conditions—and provides the basis for the broadest possible assessments and final decisions.

What i claim is:

1 An aid to idea processing comprising a viewable information carrier, the carrier having areas capable of receiving relevant notations of a process directed to an objective so as to represent the essentially dynamic relationships in a structural manner.

2. An aid as claimed in claim 1 where in the carrier prompts notations.

3. An aid as claimed in claim 1 wherein the carrier is contained in an electronic storage device in association with electronic data processing means.

4. An aid as claimed in claim 1 wherein the carrier comprises a template.

5. An aid as claimed in claim 4 wherein the template prompts identifications of problems and/or opportunities to be considered.

6. An aid as claimed in claim 4 wherein the template prompts identification of causal features and/or precursors to action and/or non-critical problems and/or impedimental factors.

7. An aid as claimed in claim 4 wherein the template prompts identifications of resources.

8. An aid as claimed in claim 4 wherein the template prompts identifications of generative and/or structural elements.

9. An aid as claimed in claim 4 wherein the template prompts identifications of operative elements or agents.

10. An aid as claimed in claim 4 wherein the template prompts the identification of the operations themselves.

11. An aid as claimed in claim 4 wherein the template prompts identification of an objective of positive operative elements.

12. An aid as claimed in claim 4 wherein the template prompts identification of one or more of initial benefits, long term benefits, ancillary consequences, negative consequences, and/or remedies.

13. An aid as claimed in claim 4 wherein the template provides areas for positive notations and areas for negative non-critical, or irrelevant notations.

14. An aid as claimed in claim 4 above wherein the template further prompts current conditions, proposed future actions and future consequences of the proposed objectives.

15. A method of planning or holding a meeting comprising the steps of preparing an aid to idea processing according to claim 1, distributing the prepared aid to idea processing to intended recipients at the meeting, allowing the attending attendees to amend the aid to idea processing or prepare further aids to idea processing and collecting the amended and/or further aids to idea processing.

16. A method as claimed in claim 15 wherein the intended attendees comment on the material in the aid to idea processing.

17. A method as claimed in claim 15 wherein the distribution and collecting of the aid to idea processing is performed at least in part through one or more of an electronic network of electronic data storage and processing devices, facsimile machines, pen or pencil and paper, and chalkboards.

18. A method as claimed in claim 15 wherein the aids to idea processing are electronically stored to be available to assist preparation of later aids to idea processing.

19. A method as claimed in claim 15 wherein the aids to idea processing are coded to allow retrieval of the aids to idea processing at a later date.

20. A method as claimed in claim 19 wherein the code relates to the type of decision to be made at the meeting.

21. A method as claimed in claim 14 wherein the data processing means provides prompts for notations based on past aids to idea processing of the aid to idea processing currently being prepared.
